(19) United States
(12) Patent Application Publication
(10) Pub. No.: US 2009/0003306 A1
(43) Pub. Date: Jan. 1, 2009

(54) Dynamic time-slot allocation and QoS priority access in a mobile ad hoc network

(75) Inventors: Alexander Plutov, Ashdod (IL); Ran Reuveni, Shoham (IL)

Correspondence Address: OLIFF & BERRIDGE, PLC, P.O. BOX 320850, ALEXANDRIA, VA, 22320-4850, US

(73) Assignee: ISRAEL AEROSPACE INDUSTRIES, LTD., LOD (IL)

(21) Appl. No.: 12/149,225

(22) Filed: Apr. 29, 2008

Related U.S. Application Data
(63) Continuation-in-part of application No. PCT/IL2006/001184, filed on Oct. 15, 2006.

(30) Foreign Application Priority Data
Oct. 31, 2005 (GB) 0522197.3

(51) Int. Cl. H04J 3/00

(52) U.S. Cl. 370/348

(57) ABSTRACT

Method and system for allocating a transmission time slot to a node in a dynamic transmission network wherein nodes may have different Media Access Priority Levels. In a present schedule, each node is allocated a transmission allocation having in each transmission-access cycle a number of transmission time slots that is a function of a respective Media Access Priority Level of the node and wherein there is a registration slot allocation of at least one slot in an aggregation of cycles of communications slots. At least two nodes actively renew their respective transmission allocations in a next schedule by transmitting in at least one of its transmission allocation slots in a present schedule. Any node of the plurality of nodes may apply to the at least two nodes for allocation of at least one transmission slot in the next schedule, by transmitting a request for transmission reservation during a registration slot to the at least two nodes who are actively renewing their transmission allocation; and at least one registration slot is allocated in the next schedule.

### FIELD OF THE INVENTION

This invention relates to a method and a system for reserving access in a dynamic communications network.

### BACKGROUND OF THE INVENTION

In a static network, all nodes are static and each node gains access to the network via a well-understood and optimized protocol. However, in a dynamic environment nodes are free to change their physical location and cannot be restricted to gain access to the network only through one central node. In a dynamic network, the nodes must communicate with each other through a wireless link. The dynamic nodes are not connected directly to each other. Examples of wireless links include microwave links, radio frequency (RF) links and infrared (IR) links.

As wireless networks grow to a large number of nodes with a highly distributed network topology, the multiple access control protocol tasks are not trivial. One of the problems with wireless mobile networks is that it is very difficult for multiple access control to respond to topological changes in an efficient distributed dynamic fashion. In particular, problems arise in situations where a previously connected node is no longer connected with other nodes, because the protocol needs a quick reaction time to the changes in order to achieve a high data rate.

IL 131967A1 published Sep. 12, 2002 in the name of the present applicant and entitled “Method and system for dynamic reservation communication access in a wireless mobile network” discloses an alternative communications protocol where there are allocated two different types of time slot for allowing data transmission. One type of time slot referred to as an allocation time slot allows near neighbors to transmit to each other; while a second type of time slot referred to as a registration time slot is not intended for transmission of data between currently defined near neighbors, but rather allows nodes to transmit what amounts to an “I am here” message. All nodes receiving such a message are thus able to update their lists of near neighbors; and conversely absence of such a message by a node that is currently defined near neighbor is taken to imply that the node has moved out of broadcast range and is no longer a near neighbor.

It is stated in above-mentioned IL 131967A1 that the protocol defined therein may incorporate respective node priority, respective allocation priority, etc. substantially without loss of efficiency. It is true that the infrastructure disclosed in IL 131967A1 accommodates a priority mechanism, but the priority mechanism described therein relates to what is termed Media Access Priority Level and relates to the priority assigned by the MAC to each time slot. In practice, the underlying assumption in IL 131967A1 is that all nodes are equal in importance and on average will therefore be assigned an equal number of time slots to transmit. However, any given time slot is assigned to one specific node based on a priority that is assigned by the MAC and which changes for each slot so that, on average, all nodes have an equal number of time slots in which to transmit. No provision is made for some nodes to have an inherent priority that allows them to be allocated a larger average number of time slots than other nodes. It would therefore clearly represent an improvement over the protocol disclosed in IL 131967A1 if a priority mechanism were also provided whereby nodes having higher inherent priorities are allocated a higher average number of time slots than nodes with normal inherent priorities that are allocated a lower average number of time slots.

Channel allocation in dynamic networks that provide priority mechanisms are well known in the art. Above-mentioned U.S. Pat. No. 5,396,644 teaches one approach and since then other different approaches have been proposed.

For example, US 2004/0100929A1 to Nokia Corporation published May 27, 2004 discloses a system and method for enabling a collision-free transmission of a packet in a network by employing an access-point tree optimized MAC (ATOM) mechanism. The system enables a node in an ad hoc network to determine a collision-free transmission schedule based in part on information the node has about a distance to an access point along a routing tree rooted at the access point. The node may be assigned a time slot for collision-free transmission based in part on a bandwidth demand at the node, and traffic the node has to forward on behalf of a neighbor node.

Likewise, US 2004/0203820A1 to Harris Corporation published Oct. 14, 2004 discloses a method for allocating channels in a mobile ad hoc network having a plurality of wireless mobile nodes and a plurality of wireless communication links connecting the plurality of nodes together over a plurality of channels. Each node monitors link performance on a first channel based upon at least one quality of service (QoS) priority access threshold, and each node scouts one or more other available channels when the monitored link performance on the first channel falls below a QoS threshold that may be based upon priority among other parameters.

QoS priority access is achieved in many known systems by using RTS/CTS synchronous transmission between nodes and thus requires handshaking. Thus, for example, WO 2004/109473 (Baker et al.) published Dec. 16, 2004 describes a system and method for a media access control (MAC) scheduling algorithm having a distributed, self-coordinating approach to provide use fairness and service differentiation in an ad hoc network by using control RTS/CTS messages carrying node status information. A local scheduling algorithm uses the overheard RTS/CTS information with attributes specifying nodes' status to maximize the awareness of the neighborhood status for a multi-channel system where data and ACK messages are transmitted through different data channels. The algorithm can both calculate the priority level based on the node queue status, and calculate the priority level based on the neighbor status, to break the contention tiers and enable the service differentiation.

Likewise, WO 2004/077225 (Zihua et al.) published Sep. 2, 2004 discloses a method that provides differentiated quality of service (QoS) by providing adaptive updates to media access control (MAC) layer parameters on a distributed basis using the IEEE 802.11 protocol. The 802.11 protocol is synchronous and requires handshaking between sending and receiving devices. It would be preferable to employ an asynchronous protocol as used in our IL 131967 so as to avoid the need for handshaking while nevertheless allowing nodes to have different Media Access Priority Levels.

However, extension of the communications protocol described in IL 131967A1 to accommodate a priority schedule is not a trivial matter and since the basic infrastructure described in IL 131967A1 is quite different from that described in other known protocols such as the above-mentioned published patent applications, it is apparent that features of known approaches relating to priority allocation cannot readily be incorporated in the infrastructure of IL 131967A1.

US2004184477 (Tavli et al.) discloses a network, such as a radio network, using dynamic transmission scheduling and soft clustering. When nodes contend for data slots, each node that is successful continues to have its data slot reserved for it until it sets an end-of-stream bit in an information summarization packet, indicating that it will stop broadcasting. From the information summarization packets, each node determines the other nodes to which it will listen, based on proximity and information content.

U.S. Pat. No. 6,711,177 (Young) discloses a method and system for managing communication resources between nodes in a network, and more particularly to a dynamic distributed multi-channel time division multiple access (TDMA) slot assignment method is presented. The method and apparatus include a set of higher level heuristics that enable the wireless channel access scheme to address predetermined characteristics of the wireless channel access system. These predetermined heuristics include using bootstrap slots, adaptive broadcast cycles, channelized neighborhoods, neighbor segregation, frame fitting, hard circuits, and soft circuits.

These approaches relate to TDMA protocols where channel synchronization is achieved by sending timing advance commands from the base station which inform the mobile nodes when to transmit. They are thus not suited for use in a distributed mobile ad hoc transmission network.

US2005122989 corresponding to WO05062538 discloses a method and apparatus to estimate a collision rate parameter by manipulating a first probability value with a second probability value. The first probability value may be the probability of an attempt to transmit a data packet within a desired time slot of a contention window. The second probability value may be a probability of data packet transmitted from the desired time slot within the contention window to collide with an at least one other data packet transmitted by other station of wireless communication network. This reference relates not to TDMA but to Carrier Sense Multiple Access (CSMA), where nodes randomly select time slots thus giving rise to collisions.

### Abbreviations and Definitions Used

D1(nᵢ)set A set of near neighbors of nᵢ (one hop nodes or near neighbor nodes or B nodes) that contains all nodes within its communication range and received before by nᵢ.

D2(nᵢ)set A set of far neighbors of nᵢ(two hop nodes or far neighbor nodes or C nodes) that contains all nodes within communication range and received before by all nⱼ ε D1(nᵢ) i.e. nⱼ belongs to the set D1(nᵢ)

ID A unique node identity number.

ICMA Idle-Signal Casting Multiple Access

ICMA-CD ICMA with Collision-Detection

PRMA Packet Reservation Multiple Access

ALOHA An early (1975) packet radio net

CDMA Code Division Multiple Access

FDMA Frequency Division Multiple Access

TDMA Time Division Multiple Access

D-TDMA Distributed—Time Division Multiple Access

MAC Media Access Control: A communication term referring to the method of controlling access to a media.

MANET Mobile ad hoc network

TS A Transmission Slot having a predetermined accesses time slot status of a transmission opportunity.

STSA Silent Time Slot having a predetermined Access time slot status of a revoked transmission opportunity.

CTS A candidate transmission slot having a predetermined accesses time slot status of a desire for transmission opportunity.

RS A registration slot having a predetermined access time slot status of a registration opportunity.

OTS Occupied Transmission Slot: A slot having a predetermined access time slot status of a transmission opportunity for a node having highest MAPL among near nodes.

MATSP Media Access Time Slot Priority indicated by a priority access right to communication channel of said time slot.

MAPL Media Access Priority Level indicated by a priority access right to communication channel and defined in according with variable transmission node requirements.

HPN Highest media access Priority Node indicated by a highest priority access right to communication channel of said node in said time slot.

Aggregation At least two

### SUMMARY OF THE INVENTION

It is therefore an object of the present invention to provide a priority mechanism in the protocol disclosed in IL 131967 whereby nodes having higher priorities are given transmission priority over nodes with lower priorities and where provision is made for some time slots to have an inherent priority that allows them to be allocated a larger average number of time slots than other nodes and the other nodes allocated a lower average number of time slots. It will be understood that if demand is low such that not all available time slots are utilized, then all nodes are able to transmit without apparent constraint and, in such conditions, the benefit of the present invention over IL 131967 is not manifested. However, the present invention allows high priority nodes to transmit during a higher average number of time slots than other nodes. This means that when the system is operating at full capacity, the lower capacity nodes will be allocated fewer time slots than they would be in IL 131967, where all nodes are allocated the same average number of time slots.

This object is realized by a new protocol that will be known as the Multi Hop—Distributed Contention Resolution with Quality of Service MAC protocol, and abbreviated to the MH-DCR/QoS MAC protocol.

This object is realized in accordance with a first aspect of the invention by method for allocating a transmission time slot to a node in a distributed mobile ad hoc transmission network having a plurality of nodes each having transmitting and receiving capability via a common communications channel using a predetermined protocol and each having a respective Media Access Priority Level within a range of Media Access Priority Levels such that any two nodes may have different Media Access Priority Levels, the method comprising:

mutually synchronizing according to a global time schedule, among at least two of the nodes, substantially repeating transmission-access cycles of communications slots;

scheduling, among the at least two nodes, a present schedule of transmission reservations wherein each of the at least two nodes is allocated a transmission allocation having in each transmission-access cycle a number of transmission time slots that define a nominal priority (MATSP) for each node based on its position in the transmission schedule for the respective time slot, and wherein said nominal priority is further refined based on the respective Media Access Priority Level of the node and wherein there is a registration slot allocation of at least one slot in an aggregation of cycles of communications slots; and

each of the at least two nodes maintaining a next schedule of transmission reservations, such that:

at least two of the at least two nodes actively renew their respective transmission allocations in a next schedule by transmitting in at least one of its transmission allocation slots in a present schedule for which its nominal priority (MATSP) is highest and there is no other node that wants to transmit in said time slot that has a higher MAPL priority;

any node of the plurality of nodes may apply to the at least two nodes for allocation of at least one transmission slot in the next schedule, by said any node transmitting during a registration slot to the at least two nodes who are actively renewing their transmission allocation; and

at least one registration slot is allocated in the next schedule.

The present invention relates to the system-implemented protocol described in IL 131967 for dynamically scheduling communications slots to participants who share a single communications channel. However, it represents an improvement over the protocol described therein in that each node has a respective Media Access Priority level within a range of Media Access Priority levels such that any two nodes may have different Media Access Priority levels. In practice, the communications protocol is implemented by a system controller that allows for communication between participating nodes and is responsible for allocating and updating system parameters that may depend on a specific application. Such parameters may include, for example, the number of nodes and respective priorities. By way of example, a system with multiple access control is a packet radio network, where not all nodes can communicate with all others owing to physical limitations of the transceiver, noise or transmission interference. In an embodiment of the invention, the Media Access Priority level lies within a range 1 to 10 (10 being the highest) and each node selects a priority level via the controller. As noted, this is different from IL 131967 where all nodes must have an identical effective MAPL.

According to a simplified view of the present invention, during a registration-slot of a current established schedule, a node broadcasts a request for a communications-slot allocation scheduling to all nodes within the broadcast distance. This request's broadcast transmission may collide with a request from another node. Whenever a collision occurs, the broadcasting nodes are aware that it has occurred, and will resort to a known collision avoidance procedure, such as recursive backing off.

When there is no collision, then all nodes in the broadcast range (including the requesting node) use an identical scheduling algorithm to update respective internal schedule allocation tables, and identically allocate a communications slot to the requesting node.

Conversely, an allocation is understood by each node to be abandoned if no transmission is received therein. This allows all nodes to free unused slots for re-allocation, again using an identical scheduling algorithm. More specifically, on the one hand, a node abandons its allocation by not using it (by not transmitting during that slot). However, on the other hand, if a transmission is perturbed, e.g. due to collision, then it too is not received, which results in this allocation being inadvertently abandoned.

Periodically each node broadcasts its respective schedule allocation table. This allows new nodes entering into broadcast range to incorporate schedule restrictions from the schedule in use in the current broadcast region. In order to avoid transmission collisions, nodes also periodically share with each other lists of neighbors who are physically close enough to the common broadcast area. To this end, near neighbors send to each other the identities of all their near neighbors. This also restores any inadvertently abandoned allocations.

The protocol basically optimizes common-channel communications allocations with respect to five factors:

nodes in a broadcast region, nodes in immediately peripheral broadcast regions to the broadcast region,

nodes allocated slots in a current schedule,

nodes abandoning slots in a current schedule by not using them,

nodes applying for a slot in a next slot allocation schedule, and

slot resources that are used for periodically sharing schedule-type information.

Inherent to this protocol is the ability for nodes to request different respective size allocations, fully or partially to abandon those allocations, and to request new or additional allocations. It is to be noted that while the system disclosed in our earlier IL 131967 also provided the infrastructure for allowing this, no actual mechanism is described that allows this feature to be realized. In aggregate, these factors allow unusually high common-channel allocation-efficiencies to be achieved. Furthermore, the protocol may incorporate respective node priority, respective allocation priority, etc. substantially without loss of efficiency.

More specifically, the present invention relates to a communication Medium Access Control (MAC) protocol for a mobile network having a number of mobile nodes and more particularly to a protocol for providing high-efficiency distributed control to shared media between mobile network nodes for data communication between neighboring nodes or even between nodes and a base node.

Communication between mobile nodes, or between a mobile node and a base node in a mobile network, is a classical problem of multiple access using a shared common channel. The exchange of information between the mobile nodes uses time-division multiple access with distributed control access reservations (D-TDMA). In a communication system serving a plurality of multiple access mobile nodes using a shared common channel, high capacity is achieved using feedback status scheduling of the data transmissions and using high efficient, distributed control. High capacity is provided using distributed control, even in cases of highly distributed network topologies, resulting in automatic defining of conflict-free vectors. In mobile networks with distributed network topology, when each mobile node communicates with other nodes, it is very difficult to assign central control to a node and only distributed control is possible. Furthermore, those versed in the art will recognize that FDMA and CDMA may also be implemented in a very similar way to the present embodiments of the D-TDMA. Therefore, in the context of the present invention, references to D-TDMA will be understood to embrace FDMA and CDMA also.

Each node is synchronized to a transmission cycle period, which is divided into time slots. Each mobile node stores node identifying information, a scheduling defining a plan of intended transmissions to be carried out by the node, the node's MAPL as well as the respective MAPL's of the node's near neighbors and the MATSP data, which is common to all nodes. Each node transmits a control message, which includes the node's identifying information, topology table information that is known by each node and feedback status scheduling of the medium access information for a subsequent transmission cycle. When a given node receives a message transmitted from another node, the given node is responsive to a control message from its neighbor node for self status scheduling of the data transmissions, based upon the scheduling of the other nodes and in accordance with access identification priority data.

The MAC protocol of the present invention is also applicable to other types of radio or wire-based channels.

The MAC protocol includes a self-organization method for building a topology table of a mobile network at each node. This results in an exchanging of topology information between nodes. A fast reaction to network topology changes is achieved, because these efficient adaptive methods are used in fully automatic network organization, without any prior knowledge of network topology.

According to the MAC protocol of the present invention, provision is made for dividing a time slot, during which the plurality of communication nodes is capable of accessing the shared communication channel.

More specifically, the present invention is implemented to achieve a better bandwidth exploitation that allows higher network performance. Accordingly, a number of specific mathematical entities need to be defined. In the context of the present invention, network topology can be performed as graph G=(N, L), where “N” is the node (vertex) set and “L” the links (edges) set of “G”.

Also in the context of the present invention, two nodes are adjacent if they are incident to a common link. The link “I” between two adjacent nodes (u, v) is defined such that node “u” is able to receive transmissions from node “v”. The set of neighbors of a node “n” is the set of nodes that are adjacent to “n”. The length of a walk is the number of links in the sequence defining the walk. If “u” and “v” are nodes, the distance from “u” to “v” is the minimum length of any path from “u” to “v”. The set of nodes, Di(n), of a node “n” is the set of nodes with distance “i” from node “n”. Therefore, D1(n) is equal to the set of near neighbors of a node “n”. In some situations the node “u” is able to receive transmissions from node “v”, but the node “v” is unable to receive transmissions of node Thus, as a condition of the transmission by the node “u” without interference, it is required none of its near or far neighbors transmits i.e. that all nodes in the sets D1(u) and D2(u) are not transmitting. For example, referring to FIG. 1, it is assumed that nodes 1 and 4 are near neighbors of both nodes 2 and 3; but that nodes 1 and 4 are far neighbors and that node 2 and 3 are far neighbors. If nodes 1 and 3 transmit simultaneously, node 2 receives a frame from node 1 and node 4 receives a frame from node 3. However, the nodes 2 and 3 transmitting simultaneously will cause interference between nodes 1 and 4. Now, by definition a conflict-free links set, via its nodes, can transmit simultaneously without interference. For example, the links (1, 2) with (3, 4) constitute a conflict-free links set. The defining of a conflict-free links set is a very difficult problem, especially in a mobile network, where a conflict-free links set can change, as result of network topology changes.

In accordance with the present invention, some disadvantages of wireless communication networks are overcome. The protocol of the present invention provides for distributed multiple access control of a wireless communication network that allows definition of a conflict-free links subset, so that the resulting network achieves high data rates while allowing different priorities to be assigned to different nodes so that any two nodes may have different Media Access Priority levels.

In the D-TDMA protocol, time is divided into cycles. Each cycle contains S time slots for data communication. The mobile node uses these slots for transmission of frames that contain address, control and information parts. Each mobile node uses the control part to inform other mobile nodes of status slots information for the next cycle. The status slot can be TS, STS, CTS, or RS as defined above.

According to a second aspect, the present invention relates to a method for reserving access in a communications network, said network having a plurality of nodes each having transmitting and receiving capability with respect to a common single communications channel in accordance with a predetermined protocol and each of said nodes having a predetermined unique identifier, the method comprising:

logically dividing a time domain of the channel into a predetermined aggregation of cyclically repeating slots, and among the plurality of nodes synchronizing the time domain for the slots or for a predetermined plurality thereof; and

among the plurality of nodes scheduling and maintaining a dynamic transmission reservation schedule wherein each node is allocated at least one slot in each aggregation and wherein at least one registration slot is allocated in each aggregation for use by any new node applying to become included as a member in a future transmission reservation schedule; wherein each node in the plurality maintains its membership in the transmission reservation schedule by transmitting in at least one of its allocated slots in each aggregation;

each node in the plurality deletes any other node from membership in each of said node's maintained transmission reservation schedule when said other node fails to maintain his membership; and

any node, new or otherwise, may apply to the remaining members of the plurality for allocation of a slot in the transmission reservation schedule, by said any node transmitting, during one of the at least one registration slot, at least his unique identifier as a request for reservation access and membership.

According to a third aspect, the present invention relates to wireless communication networking method for mobile nodes interconnecting and sharing a communication channel, the method comprising:

establishing a distributed medium access control protocol, defining interchanging access status of time slots for every next time cycle between nodes, and access identification priority data for all nodes;

dividing the communication channel as a function of time into cycles each having a predetermined number of S time slots;

global time synchronizing the communication channel for each node of a plurality of maximum N mobile nodes;

for each node, defining a unique identifier and a respective Media Access Priority level within a range of Media Access Priority Levels such that any two nodes may have different Media Access Priority Levels;

for each node, providing a transmitter and a receiver substantially serving a mutual communication coverage area for transmitting and receiving of frames therein on the channel in broadcast mode;

scheduling a mutually exclusive transmission schedule wherein each node determines access status of time slots for a respective next time cycle that is a function of the respective Media Access Priority Level of the node and whether data is to be transmitted by the node and wherein there is a registration slot allocation of at least one slot in an aggregation of cycles of communications slots; and

transmitting according to the transmission schedule whereby each mobile node transmits a frame during a time slot when there is a calculated high probability of accessing the shared communication channel in accordance with access identification MATSP data for all nodes and in accordance with MAPL data for all near nodes of the transmission schedule.

These three aspects of the present invention substantially relate to a single methodology. Those versed in the art will appreciate that implementing such a methodology includes numerous design decisions, which alter how a system embodying this method will be analyzed and appreciated. It is for the convenience of a de facto analysis and appreciation that the present method has been described from the perspective of three different inter-related aspects.

A network, especially one of mobile nodes, is a complex unstable topology communications construct. The purpose of the network is to assure various services, such as information exchange, remote access to systems, distributed computation, and information retransmission. The Media Access Control (MAC) algorithm of the present invention allows many network nodes to share media, for effective data communication in a network. This network algorithm meets requirements for reliable, high-rate continuous data transmission.

Some main characteristics of the network according to the preferred embodiment of the present invention are:

The network has mobile nodes that can change position, thus the network topology can change over time and can contain unlinked nodes. Also the network may have a number of static nodes.

A transmission mode permits information to be transmitted to all nodes in the network that are intended to receive a transmission such that everyone in broadcast range is obliged to hear

Each node can only either transmit or receive during any given time slot.

There is a constant need for an interchange of information between nodes.

Each node can receive from only one node during any given time slot.

The MAC algorithm performs dynamic reservation of access time.

Furthermore, and in accordance with at least one of the specific methodological aspects as heretofore described, the present invention relates to a wireless communication networking system comprising a plurality of maximum N mobile nodes, such that:

each mobile node has a processor, a transmitter and a receiver both coupled to the processor,

the mobile nodes interconnect to and thereby share a communication channel in accordance with a predetermined distributed medium access control protocol, wherein:

the communication channel is divided into time cycles each having a predetermined number of S time slots, and

the communication channel is global time synchronized for each node of the plurality of mobile nodes;

each node has a predetermined unique identifier and a respective Media Access Priority Level within a range of Media Access Priority Levels such that any two nodes may have different Media Access Priority levels;

the transmitter and the receiver of each node substantially serve a mutual communication coverage area for transmitting and receiving of frames therein on the channel in broadcast mode; and

the transmitting is according to a mutually exclusive transmission schedule whereby a selected mobile node (HPN) transmits a frame during a time slot when there is high priority calculated to access the shared communication channel in accordance with known MAPLs and access identification priority data for all nodes of the transmission schedule wherein:

the distributed control medium access protocol includes interchanging access status of time slots for a next time cycle between nodes using commonly defined access identification MATSP data by all nodes, and

the transmission schedule includes each node determining access status of time slots for a respective next time cycle.

### BRIEF DESCRIPTION OF THE DRAWINGS

In order to understand the invention and to see how it may be carried out in practice, some preferred embodiments will now be described, by way of non-limiting example only, with reference to the accompanying drawings, in which:

FIG. 1 is a collision-free transmission network diagram;

FIG. 2 is a spatially described network topology diagram;

FIG. 3 is a block diagram of a node network media access controller (MAC) block according to an embodiment of the invention;

FIGS. 4a and 4b are a top-level flowchart showing the principal operations carried out by the MAC for allocating transmission time slots in a communications protocol according to the invention;

FIG. 5 is a flowchart showing a detail of the communications protocol depicted in FIGS. 4a and 4b;

FIG. 6 is a pictorial representation showing the structure of an access priority data chart maintained by an MAC according to an embodiment of the invention;

FIG. 7 is a chart of access status vectors corresponding to a single column of the access priority data chart shown in FIG. 6;

FIG. 8 is a schematic tabular representation summarizing successive stages in the determination of transmission priority showing those nodes that are scheduled to transmit during each cycle; and

FIG. 9 is a chart showing scheduling of the access status during a complete cycle.

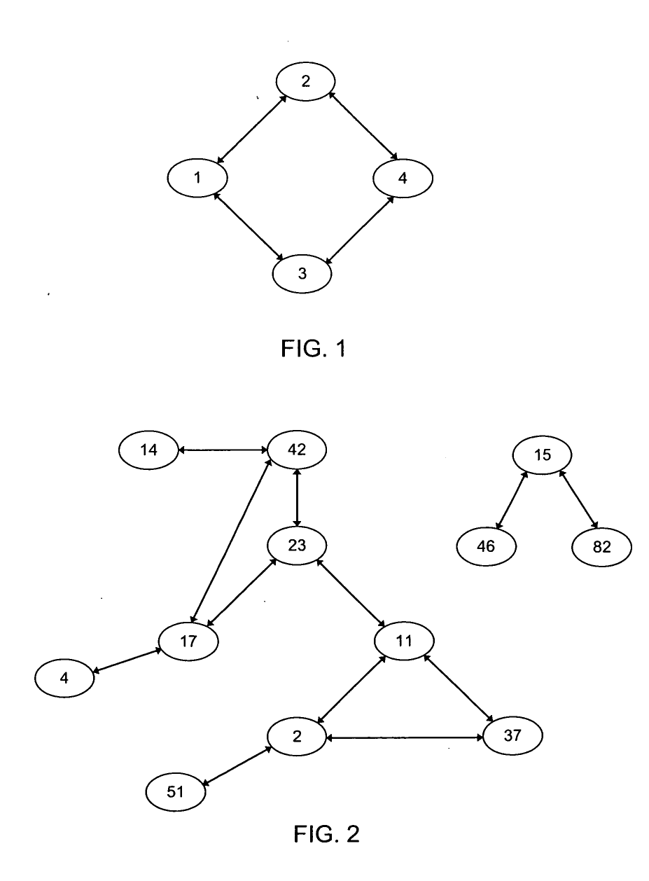

### DETAILED DESCRIPTION OF EMBODIMENTS

An embodiment of the present invention relates to a synchronous distributed medium access control protocol for wireless mobile network. The network topology is descriptive of the physical and logical relations of nodes in a network; the schematic arrangement of the links and nodes. Each node transmits a message, and thereby the neighbor nodes are informed of what nodes are to be contained in a current node table.

While a plurality of embodiments of a MAC protocol of the present invention may be described for static-node networks, the preferred embodiments relate to a method and a system for actualizing a distributed media access control method with dynamic reservation of access time according to predetermined node priorities in mobile networks.

### Mathematical and Physical Definition

The MAC method of the present invention allows for data communication between a finite number N of mobile nodes, wherein each of the nodes can both transmit and receive data over a maximum predetermined communication range C (defined by transceiver parameters) and may receive only one data communication at any given time.

### Transmissions without Collision

For a better understanding of the method some of the terminology will now be described, with reference to the accompanying drawings.

FIG. 2 shows a network topology, where a node having indices ij will be identified by the notation nᵢⱼ. Thus, node n₂₃ is surrounded by series of other nodes n₁₁, n₁₇, n₄₂ all of which are in a communication range C of the node n₂₃ and are therefore near neighbors of the node n₂₃. Within a communication range C of each of the nodes n₁₁, n₁₇, n₄₂ are additional nodes n₂, n₄, n₁₄ and n₃₇ whose distance from the node n₂₃ exceeds C and are therefore far neighbors of the node n₂₃.

During the following explanation, the near neighbors of n₂₃ i.e. nodes n₁₁, n₁₇ and n₄₂ will be denoted by D1(n₂₃)and the far neighbors of n₂₃ i.e. nodes n₂, n₄, n₁₄ will be denoted as D2(n₂₃). Since the maximum distance from n₂₃ to a near neighbor D1(n₂₃) is equal to C and the maximum distance from that near neighbors D1(n₂₃) to a far neighbor D2(n₂₃) is likewise equal to C, it follows that the maximum distance between n₂₃ and the furthest D2(n₂₃) nodes is equal to 2 C.

The D1(n₂₃) nodes are all within communication range of n₂₃. Clearly, they may not necessarily all be within communication range of each other since, for example, the distance between the node n₄₂ and the node n₁₁ clearly exceeds C. In the method that will be described with particular reference to the node n₂₃, it is to be understood that exactly the same rules apply to all nodes of the network. These rules provide that some node nᵢ can both transmit data to and receive data from all of its near neighbors D1(nᵢ) without any danger of collision with similar data transmissions in respect of adjacent sets of nodes.

Note that a node that is in D1 cannot also be in D2 and vice versa, i.e. D1(nᵢ)∩D2(nᵢ)=Ø.

It is also to be noted that FIG. 2 shown a typical network topology showing two groups of nodes with no node from first group being in communication range with a node from the second group. Thus, there are effectively two separate sub networks both communicating via the same communication channel. For convenience of description, these will be referred to as sub-network 1 (having the larger number of nodes) and sub-network 2 (having the fewer number of nodes).

In such a system, the processing unit operates in accordance with the method constraints and definitions, as described.

The data communication is effected in a series of cycles, each one of which contains S time slots. In a complete communication cycle, each node nᵢ will become aware of any new near neighbors within its communication range and will be informed by its near neighbors D1(nᵢ) of all new far neighbors.

As is explained in the following section, each node transmits during a pre-allocated time slot according to a MATSP allocation assigned to the nodes by a MAC unit associated with each node and based on a predetermined MAPL assigned to each node by an external application, so that nodes may have an inherent MAPL that allows them to be allocated a larger average number of time slots than other nodes. When the node nᵢ transmits during one of the time slots, all of its near neighbors D1(nᵢ) will hear it, because each member of D1(nᵢ) and D2(nᵢ) are silent. This follows since, during the time slot that nᵢ transmits, all of nᵢ's neighbors D1(nᵢ) and D2(nᵢ) have lower MATSP and furthermore, because its near neighbors D1(nᵢ) and its far neighbors D2(nᵢ) are aware of nᵢ's existence and will therefore not attempt to communicate with each other during this time slot. On the other hand, nodes other than nᵢ's near neighbors D1(nᵢ) and far neighbors D2(nᵢ) can indeed transmit at the same time as nᵢ without danger of interference with nᵢ. Thus, the network without any full link topology will have high-rate continuous data transmission, because several non-interfering nᵢ-type nodes can transmit data in the same time slots.

### Distributed Solution Synchronization

Synchronization may be accomplished using a temporal feature that is common and accessible for all nodes of the system. In an embodiment of the present invention, a distributed synchronization solution uses transmission access identification MATSP data that is common and uniform for the whole network, e.g. a transmit or receive in a current slot.

Access identification MATSP data sets each having a size equal to N_{max nodes} are allocated one for each of the time slots. The access identification MATSP data sets are arranged so that each node appears only once and in a different position in each set. The access identification MATSP data sets are arranged so that there is minimum correlation between sets.

The access identification MATSP data sets are identical for all of the nodes. Thus, during any given general time slot, any node may transmit data if it has a higher MATSP than all of both its D1(nᵢ) and D2(nᵢ) nodes.

### Context Diagram with Network MAC Block

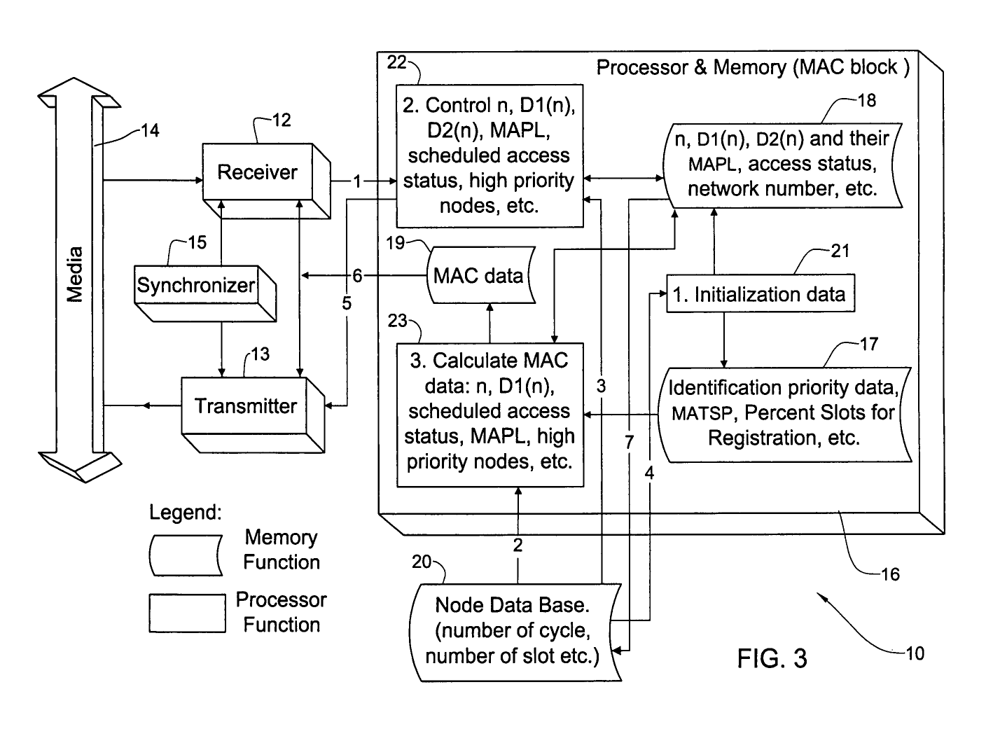

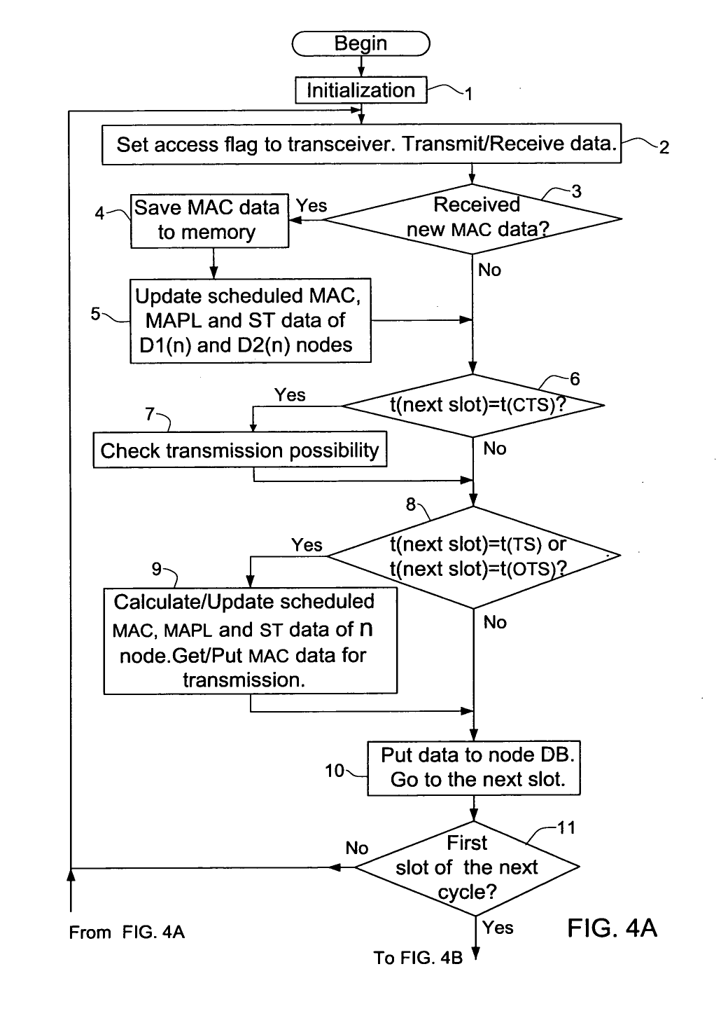

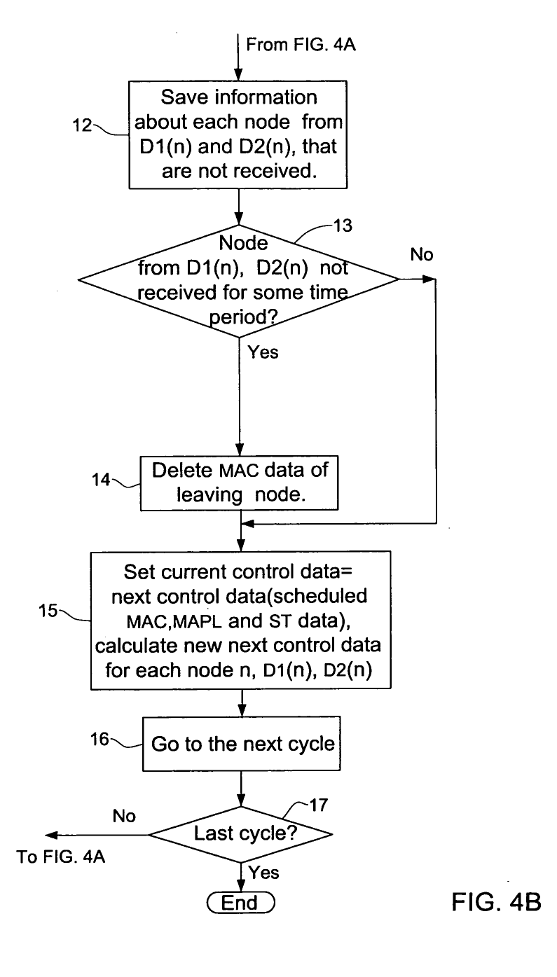

FIG. 3 shows the functionality of part of a network communication system 10 having a plurality of mobile nodes, of which one representative node 11 is shown including a receiver 12 and a transmitter 13 coupled to a media channel 14 that is common to all nodes in the system. A synchronizer 15 is coupled to the receiver 12 and a transmitter 13 for synchronizing between TDMA transmission and reception. The system 10 further includes a respective MAC block 16 for each node in the system for enabling communication between different nodes using the communications protocol according to the invention as will be described below with particular reference to FIGS. 4 to 9 of the drawings. In each MAC block, the updating of D1(nᵢ) and D2(nᵢ)in response to transmissions received from near neighbors or to the persistent absence of such transmissions and the next slot MAC data calculations are executed once at the start of each current slot.

The MAC 16 includes first, second and third memories 17, 18 and 19 for storing access identification MATSP data, listings of D1(nᵢ), D2(nᵢ) nodes of the respective node, and calculation results, respectively. It will be appreciated that the three memories are shown separately for ease of explanation, but in practice may be realized by a single memory unit or by a different number of distributed memory units. A fourth memory unit 20 is provided as part of a system controller (not shown) and stores global data associated with the system 10 that must be accessible to all nodes, such as the node database, number of the current cycle, slot number and so on. Significantly, so far as the present invention is concerned, the fourth memory 20 stores a Media Access Priority Level in respect of each of the nodes that allows different nodes to be allocated a larger average number of time slots than other nodes based on a MAPL schedule that is or system-dependent and determined in accordance with the specific application to which the system is dedicated.

The MAC 16 also includes first, second and third processing units 21, 22 and 23 for performing data initialization, control and calculation respectively. Here, too, it is convenient to describe the functionality of the MAC 16 in terms of separate processors but in practice a single processing unit may be employed.

FIG. 3 shows that data flows between the receiver 12, transmitter 13 and the MAC 16 are as follows:

### Input:

1. nⱼ ε D1(nᵢ), destination node nᵢ, D1(nⱼ), scheduled access status of nⱼ, high MATSP nodes known to nᵢ.

2. Number of cycle, number of slot.

3. Number of cycle, number of slot, net number of nᵢ.

4. nᵢ, Number of cycle, number of slot.

### Output:

5. n₁, Destination node nⱼ, D1(nᵢ), scheduled access status of nᵢ,

6. MAC data.

7. Transmitted/Received data of nᵢ.

Thus, there is provided in respect of each of the nodes a receiver 12 and a transmitter 13. Access identification MATSP data relating to Media Access Time Slot priorities is stored in the first memory 17 together with a value defining a percentage of highest MATSP that must be released as registration slots. The listings of D1(nᵢ), D2(nᵢ) nodes of the respective node are stored in the second memory 18. The initialization of the data, stored in the first and second memories, is executed by the first processing unit 21 in the MAC 16.

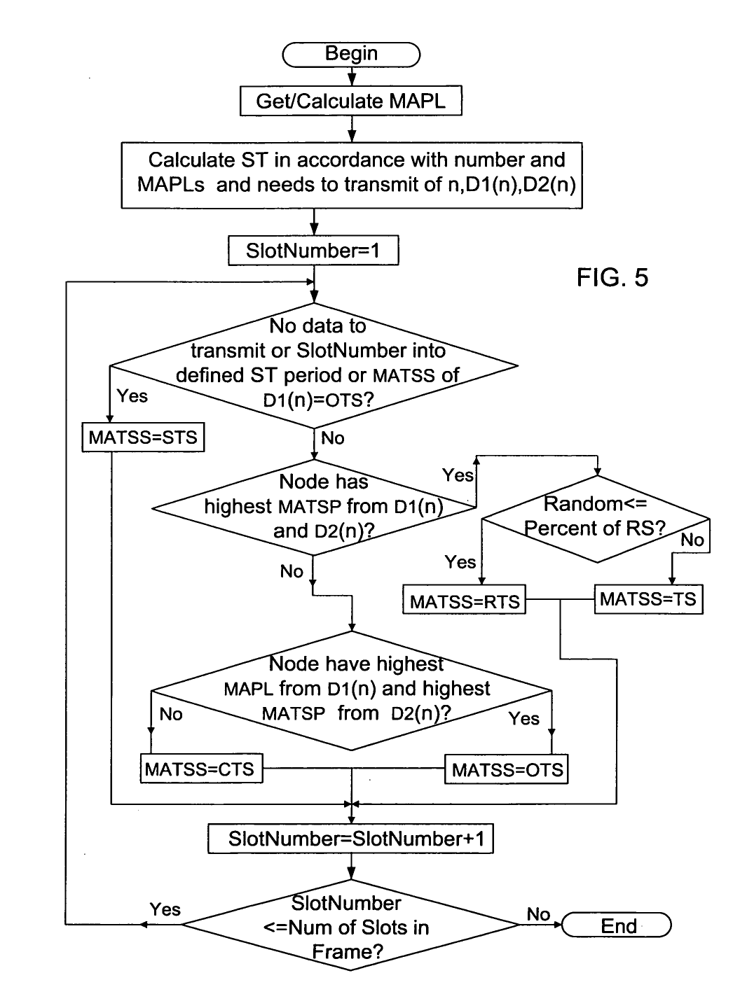

FIGS. 4 and 5 are flowcharts showing the principal operations carried out by the MAC for implementing the communication protocol of the invention in accordance with an embodiment. After initialization, an access flag is set for the transceiver of the respective node, allowing the node to transmit and receive data. At the beginning of the current slot a further check is made by the third processing unit 23 in order to derive the appropriate access identification MATSP data stored in the first memory 17 for that time slot. For reach node, the scheduled MAC data as identified in block 3 of FIG. 3, and the MAPL and ST data of all near and far neighbors D1(n) and D2(n), respectively, are updated. The status of the next time slot is then examined as it pertains to the current node. This is done for all nodes by their respective MAC 16 so as to generate node data that will be used during the next cycle for what will then be the current time slots. If the next time slot is registered as a candidate time slot for the current node, this means that the current node wants to transmit during the next cycle. In this case, the possibility for transmission by this node is checked. If the current node is not a candidate for transmission for the next time slot, the algorithm checks whether the time slot is a Transmit Slot (TS) or an Occupied Time Slot (OTS). A time slot may be occupied by a node if it wishes to transmit during that time slot and determines that it has the highest MAPL. If this happens, then the highest MAPL node captures the time slot and, so far as other nodes are concerned, the time slot is said to be occupied. In either case, where the node wishes to transmit during the next time slot, the third processing unit 23 calculates and updates the scheduled MAC, MAPL and ST data of the current node and obtains the MAC data for transmission, as explained below with reference to FIG. 5 of the drawings. Thereafter, or in the case that the node does not wish to transmit during the next time slot, the calculated node data is saved in the third memory 19. An index pointing to the next slot in the current cycle is then incremented and the same procedure repeated as necessary for each slot in the current cycle. When the index points to the first slot in the next cycle, the MAC data is saved in the second memory 18 about each of the near and far neighbors of each node nᵢ, i.e. D1(nᵢ) and D2(nᵢ) from which no transmission was received in the current cycle even though it is known from previous cycles that they exist. On the other hand, it is assumed that all near and far neighbors D1(nᵢ) and D2(nᵢ) of a node nᵢ from which no transmission has been received for a threshold time period of several cycles have moved beyond broadcast range of the node nᵢ. The MAC data of such “absent” nodes is deleted together with the MAC data of all other nodes that are connected only to such absent nodes. The current control data is then set to scheduled MAC, MAPL and ST data that was previously calculated and saved for what was then the next cycle and is now the current cycle, since the index points to a new cycle. The whole process is then repeated for successive cycles as required.

Referring now to FIG. 5, the operations relating to calculation of the Media Access Priority Level (MAPL) will be described on more detail. Before doing so, some brief general explanation will be given as to how the algorithm operates in a general sense. Time slots are allocated in each cycle depending on each node's need to transmit and on its priority. It is again emphasized that “priority” in this context is an indication of how many slots a node may be allocated in the complete cycle as determined by its MAPL, which shows the priority on a scale of 1 to 10, for example. According to one embodiment of the embodiment, priorities are assigned in ascending order so that the higher the MAPL, the higher is the priority; but it will be appreciated that this is merely a matter of choice and priorities may of course be assigned in descending order so that the lower the MAPL the higher will be the priority. It will be appreciated empirically that if a node does not need to transmit in a given cycle, this frees its slot for other nodes. Such “free” slots are referred to as Silent Time (ST) slots and the algorithm must therefore determine how many Silent Time slots there are in each cycle in order to allow re-allocation of such time slots to other nodes, based on their priority levels. On the other hand, some slots must remain silent so as to allow new nodes that are not currently near or far neighbors of those nodes currently registered in the second memory 18 of each of the nodes' MAC units 16. The reason for this is that by definition a “new” node is one that is neither a near nor a far neighbor and therefore was previously out of broadcast range but is now in broadcast range. If all time slots were shared only among those nodes that are currently registered as near or far neighbors, such new nodes would never be able to transmit their presence and thus join the group of nodes that are in communication range of each other. So, not all silent time slots may be allocated. By the same token not always is a node having the highest media access time slot priority permitted to compete for the current time slot: rather a small percentage of highest priority slots is waived in favor of new traffic. Moreover, a node nᵢ may be constrained to give preference to a new far neighbor whose MAPL is not yet known even in cases where the node nᵢ has a higher media access time slot priority than the far neighbor. In such cases the node nᵢ is constrained to be silent during the current cycle.

With this general background, some details of the algorithm will now be described with reference to FIG. 5. The silent time (ST) is calculated in accordance with the number of participants and MAPLs of nᵢ, D1(nᵢ) and D2(nᵢ),their need to transmit and the number of time slots that a node is committed to be silent. For example, the silent time (ST) of a node nᵢ may be calculated according to:

$$S T ( {n}_{i} ) = \frac{STC * ( ND 1 + ND 2 )}{( \frac{MAPL ( {n}_{1} )}{AMAPL} )}$$

where:

STC=constant silent time coefficient

ND1=number of nodes in set D1(nᵢ)

ND2=number of nodes in set D2(nᵢ)

MAPL(nᵢ)=MAPL of node nᵢ

AMAPL=average MAPL of nᵢ and D1(nᵢ) nodes

Specifically, if a node nᵢ has no need to transmit, then its time slots may be designated as ST. The slot number index is now set to point to the first slot and the algorithm checks if there is no data to be transmitted during the current slot or whether the current slot corresponds or overlaps with a predefined ST period. In such case, the media access time slot status (MATSS) is set to STS denoting that the slot is a Silent Time Slot. Otherwise, the algorithm checks whether the node nᵢ has the highest MATSP in the set of nodes defined by D1(nᵢ) and D2(nᵢ). This is a necessary, but as we will see shortly, not a sufficient condition for the node nᵢ to capture the current time slot. Thus, if the node nᵢ has a higher access time slot MATSP that all its near and far neighbors D1(nᵢ) and D2(nᵢ), this implies that the node nᵢ is a possible candidate for capturing the current time slot. In such case, as noted above, the algorithm now invokes a random release mechanism, which may free the time slot to serve as a registration slot (RS) for another node that wants to join the set of near or far neighbors of the node nᵢ, i.e. a node that moves within broadcast range of the node nᵢ. In accordance with an embodiment, the random release mechanism is designed to ensure that on average a prescribed percentage of sure slots are released. To this end, the random release mechanism allocates a random number within a prescribed range and releases the current slot (designated as an occupied time slot since it was captured by the highest MAPL node) if the random number is larger than the prescribed percentage.

On the other hand, if the node nᵢ does not have the highest MATSP in the set of nodes defined by D1(nᵢ) and D2(nᵢ), this implies that the node nᵢ is eligible to capture the current time slot. Thus, if the node nᵢ has the highest MAPL from D1(nᵢ) as well as the highest media access time slot priority this means that the current node has the highest media access priority level of all near neighbors and it is known for certain that the current node also has the highest media access time slot priority of all far neighbors. In this context, it should be noted that if a new far neighbor with unknown media access time slot priority has joined, then the current node is prohibited from capturing this time slot since it is possible that the new far neighbor will have a higher media access time slot priority. The slot number is then incremented and the whole process repeated for all time slots in the current frame.

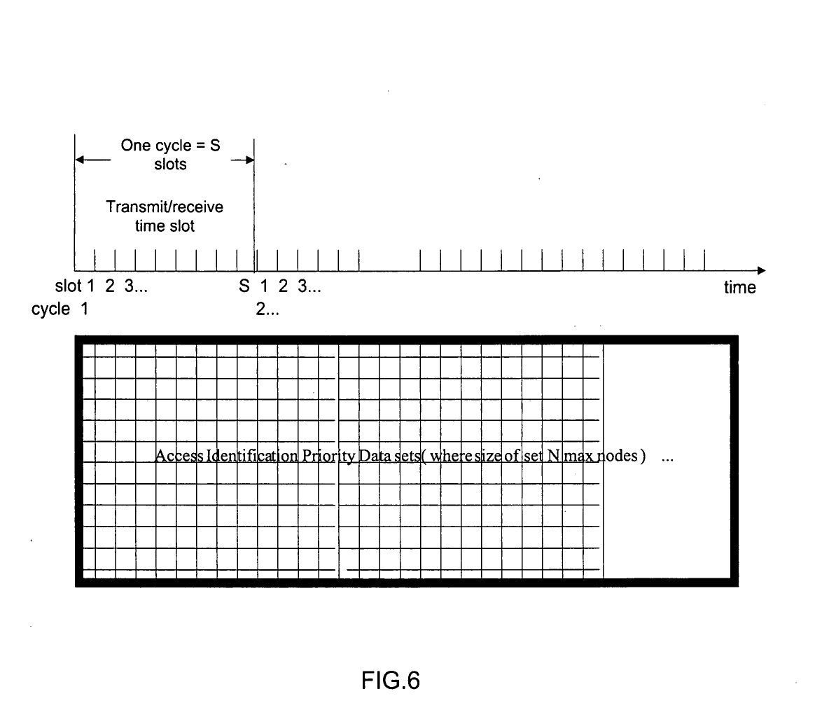

FIGS. 6 to 9 summarize schematically the internal housekeeping maintained by the MAC in allocating time slots. Thus, FIG. 6 shows the structure of an access identification priority data set whose abscissa corresponds to the time axis and shows successive cycles of time slot schedules. Each cycle contains along the time axis a respective time slot for each node, up to the maximum number of nodes supported by the application. The vertical axis represents the media access time slot priorities.

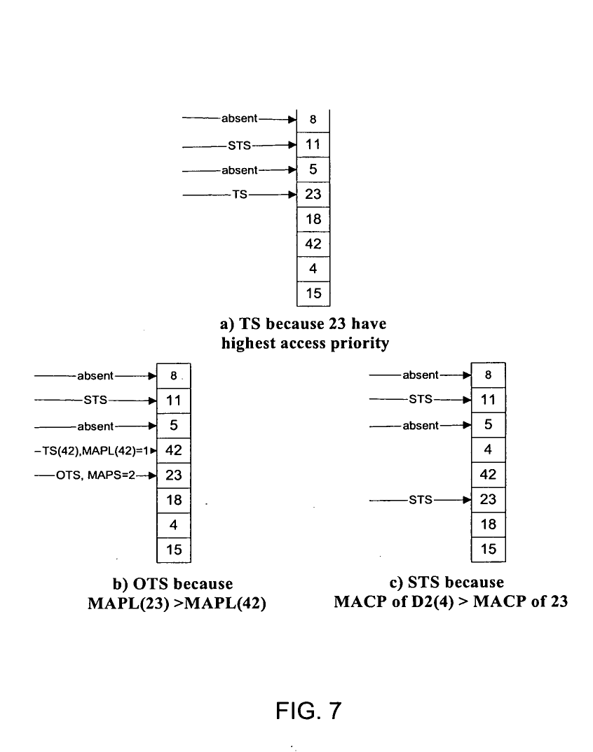

Particular reference is now made to FIGS. 7a to 7c showing different examples of time slot scheduling summarizing the above-described principles, all relating to sub-network 1 shown in FIG. 2. Thus, in FIG. 7a node 8 has the highest media access time slot priority, followed by nodes 11, 5, 23, 18, 42, 4 and 15. In IL 131967A1 this alone would dictate the order in which nodes transmit, but according to the algorithm of the present invention further processing is required based on the media access priority levels of the nodes.

It is first to be noted that node 8 is absent from FIG. 2: it thus does not belong to any of the nodes near or far neighbors. So the fact that it nominally has the highest media access time slot priority is not relevant since priority is clearly given to nodes that are within communication range, as depicted by FIG. 2. Node 11 has the next highest media access time slot priority but is indicated as STS: meaning that it has indicated that it has no data to transmit during the present cycle. Node 5 has the next highest media access time slot priority but it too is absent. Node 23 has the next highest media access time slot priority, and since this node is indeed present, its time slot TS is given transmission priority.

FIG. 7b depicts a different scenario where node 42 has a higher media access time slot priority than node 23. In IL 131967A1 this alone would dictate that node 42 transmit during the current cycle, but according to the algorithm of the present invention further processing is required based on the media access priority levels of the nodes. Thus, it is determined that the media access priority level (MAPL) of node 42 is 1, while that of node 23 is 2, which is higher than that of node 42. Therefore, in such case node 23 transmits even though its media access time slot priority is lower than that of node 42.

FIG. 7c depicts yet another scenario where node 4 has a higher media access time slot priority than node 23. However, since node 4 is a far neighbor of node 23 (as seen from FIG. 2) and therefore is not in communication range of node 23, it cannot be known whether its media access priority level (MAPL) is lower or higher than that of node 23. So in this case, node 23 is constrained to be silent during the current cycle so that node 4 is given preference.

Then it is established whether the MATSP of the respective node is greater than the respective MATSPs of all of its D1(nᵢ), D2(nᵢ) nodes whose identities are stored in the second memory 18. The result of these calculations is the one slot MAC data, which is stored in a third memory 19. If, at the current slot, a node has higher MATSP than all of both its D1(nᵢ) and D2(nᵢ) nodes, then the transmitter of the respective node is enabled and its identity together with those of its near neighbors and other control information are automatically transmitted.

In like manner, during any time slot when a respective node is disabled from transmitting, its receiver is automatically enabled for receiving any transmission of one of its near neighbors.

In this situations three main events can occur (block 2):

i. If transmission is received by node nᵢ from a node nⱼ ε D1(nᵢ), then the node nⱼ is added to D1(nᵢ) and D1(nⱼ)'s are added to D2(nᵢ).

ii. If transmission is received by node nᵢ from a node nⱼ ε D1(nᵢ), then the node D1(nⱼ)'s changes are added to D2(nᵢ).

iii. If transmission during the known time interval is not received by node nᵢ from a node nⱼ ε D1(nᵢ), then the node nⱼ is deleted from D1(nᵢ) and D1(nⱼ)'s are deleted from D2(nᵢ).

The results of these events are stored in the second memory.

The above scenarios allow the principles of the invention to be summarized as follows: media access time slot priorities (MATSP) are allocated by the MAC in conventional manner. These priorities will take effect unless a node has a higher media access priority level (MAPL) than the node having the highest MATSP. In such case, the node having the highest MATSP is given preference providing only that there is not another node having a higher MAPL and whose MATSP is not known.

### Cycle—MATSP Data Decomposition

The cycle—MATSP list decomposition of the method is shown in FIG. 7. Each time slot of the cycle is represented as conformed into one column of the access identification MATSP data set. The data communication, as described above, is effected in a series of cycles, each one containing S time slots each in respect of one of the nodes. Also, the access identification MATSP data set size, implemented in the method in a series of the sets, is equal to

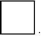

### Leaving

A further consideration is that the situation depicted in FIG. 2 is dynamic and constantly changing, because the network contains mobile nodes. That is to say, even though the node n₂₃ depicted as 23 will always be stationary relative to itself, its near and far neighbors, D1(n₂₃) and D2(n₂₃) respectively, are in a constant state of flux with different nodes both entering and leaving the communication ranges. Therefore, in general if a node nᵢ is not heard during the known time interval by one of its currently defined near neighbors D1(nᵢ), this indicates that its nⱼ ε D1(nᵢ) has moved beyond the limiting communication range C or the current nⱼ transmission was obstructed by noise, etc. Therefore, this near neighbor and its near neighbors should be deleted from D1(nᵢ) and D2(nᵢ).

In order to delete node nⱼ from D1(nᵢ)the following steps must be executed:

1) Delete nⱼ from D1(nᵢ), if nⱼ ε D1(nᵢ) and nⱼ is not received by nᵢ during the known time interval.

2) Add nⱼ to D2(nᵢ),
if ∃nₖ ε D1(nᵢ): nⱼ ε D1(nₖ) [symbol] nᵢ ε D2(nᵢ).

3) Delete nᵢ from D2(nᵢ),
if ∀nᵢ ε D1(nⱼ): ∀nₖ ε D1(nᵢ): nᵢ ∉ D2(nₖ) [symbol] nᵢ ∉ D1(nᵢ).

### Registration

As described above, as a result of the dynamic changes, the node nᵢ can receive a new near neighbor D1(nᵢ).

There are two possible cases of registration of the node nⱼ into D1(nᵢ), for the cases that nⱼ was or was not previously a member of D1(nᵢ):

CASE 1: When nⱼ ε D1(nᵢ). In this case the registration of the node nⱼ into D1(nᵢ) occurred instantly (for example nodes n₂₃ and n₂ in FIG. 2).

CASE 2: When this is not as in the Case 1 (for example nodes n₂₃ and n₄₆ in FIG. 2), then the nⱼ node is not linked with nᵢ.

To provide the ability defined in Case 2, every node of the network should release some slots for registration. To this end, as explained above with reference to FIG. 6, each node of the network releases random slots from the set of node cycle transmit slots. This means that two unlinked nodes have the ability of random detection of another node that is currently transmitting data during these slots or in the slots when the node and its near neighbors do not transmit data. In the method, a constant value R is defined as the percentage of slots for registration at each node, such that after the registration nⱼ ε D1(nⱼ).

### Changes into Far Neighbors Set

There are two possible cases of changes into far neighbors D2(nᵢ) set:

1^{ST} CASE: as a result of a registration of a new near neighbor nⱼ ε D1(nᵢ). Then calculation of new D2(nᵢ) consists of the following operations:

a) if nⱼ ε D2(nᵢ), then delete nⱼ from D2(nᵢ)

b) D2(nᵢ):=(D1(nⱼ)\D1(nᵢ))

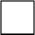

### D2(nᵢ)

2^{ND} CASE: as a result of changes within D1_{new}(nⱼ) in relation to D1_{old}(nⱼ), wherein nⱼ ε D1(nᵢ). Then calculation of new D2(nᵢ) consists of the following operations:

$$M ( {n}_{j} ) = {⋂}_{k \neq j} [ D {1}_{old} ( {n}_{j} ) \backslash D 1 ( {n}_{k} ) ] , where k = 1 - Q \qquad a )$$

and Q is the number elements of D1(nᵢ) set

b) D2(nᵢ):=(D1_{new}(nⱼ)\D1(nᵢ))

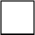

### D2(nᵢ)\M(nⱼ)).

### Collision

All nodes have the ability to sense if another node is currently transmitting data.

The fact that each node can transmit packets means that occasionally two nodes will transmit at the same time. This is known as a collision. This happens when some node does not contain full control information. In case of the MAC method, this happens when the network topology is changing and some nᵢ nodes do not receive the control information about the nⱼ node or the D1(nⱼ) nodes. This may occur during the registration process, when the new near neighbors are effecting registration, or when the nⱼ node information D1(nⱼ) is not obtained for a long time. Note, the registration between two nodes for collision-free situation must be mutual, i.e. if nᵢ ε D1(nⱼ) then it is a condition that nⱼ ε D1(nᵢ), otherwise collisions are possible. In other words, if the node nⱼ is registered as a near neighbor of the node nᵢ, then also nᵢ must be registered as a near neighbor of the node nⱼ.

### One Cycle Scheduling of the Access Status

The scheduling of a cycle access status vector is calculated from the access identification MATSP data, taking into account the sets nᵢ, D1(nᵢ), D2(nᵢ) and their respective access status vectors and also MAPLs the sets nᵢ, D1(nᵢ).

The scheduling of one cycle access status vector for a single node nᵢ consists of the following operations:

(a) determining time slots' candidate transmission status (CTS) for a node not having highest priority from a set of identifiers for nodes of distance D1(nᵢ) and D2(nᵢ);

(b) upon determining that the node in time slots has been assigned to HPN, determining time slots assignment to a transmission slot (TS) access status, within known limits for the node's own transmission data capacity and for transmission data capacity of other nodes;

(c) upon determining that the time slot has been assigned to TS access status, determining time slots reassignment to a registration slot (RS) access status, within a predetermined percent of the registration slots limitation;

(d) upon determining that the time slot has been assigned to CTS access status, determining time slots exceeding the node's own transmission data capacity, lo and reassigning these time slots to STS access status; and

(e) determining time slots for nodes of distance D1(nᵢ) as nodes having highest priority.

In this implementation scheduling of access status for next cycle before each transmission is used.

### Example (Using the Network Topology of FIG. 2)

This example shows how to determine for nodes of distance D1(nᵢ) and D2(nᵢ) which nodes have the highest priority.

The current nᵢ, D1(nᵢ) and D2(nᵢ)sets are:

n₂₃={23}; D1(n₂₃)={11,17,42}; D2(n₂₃)={2,4,14,37}.

n₁₁={11}; D1(n₁₁)={2,23,37}; D2(n₁₁)={17,42,51}.

n₂={2}; D1(n₂)={(11,37,51}; D2(n₂)={23}.

n₄₆={46}; D1(n₄₆)={15}; D2(n₄₆)={82}.

etc.

Moreover, as noted above, there are in fact two independent sets of D1(nᵢ) and D2(nᵢ)each relating to a separate sub network using the same communication channel. Sub network 1 includes nodes 14, 42, 23, 17, 4, 11, 2, 51 and 37 and sub network 2 includes nodes 46, 15 and 82.

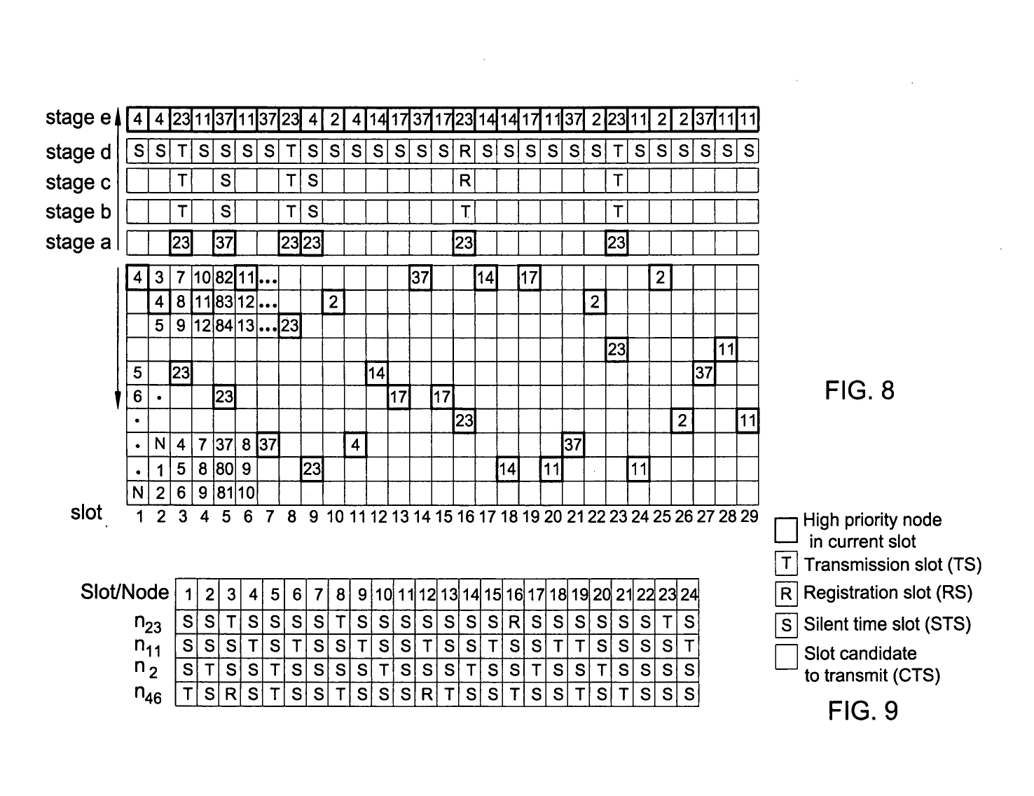

With reference to FIGS. 8 and 9, there will now be explained the operations for scheduling a one-cycle access status vector of node n₂₃ that is a member of sub network 1. FIG. 8 shows the time axis divided into multiple cycles (or aggregates) of time slots, each cycle containing S time slots. Each time slot is accorded a respective MATSP status or rank (shown blank in FIG. 6) in accordance with which it is determined which node is allowed to access the time slot. FIG. 8 shows the same situation except that here specimen priorities are shown.

In the first stage (a) relates to the allocation of a time slot in each cycle for node n₂₃. Node n₂₃ can transmit more than once in each cycle. Stage (a) determines which node is scheduled to transmit during each time slot according to the media access time slot priorities (MATSP). However, it does not take into account silent time slots wherein a node having highest priority can nevertheless waive its right to transmit.

In stage (b) the node n₂₃ selects slots where it wants to transmit. That is, after having been allocated time slots in stage (a) it now indicates whether or not it wishes to exploit the right to transmit or to establish the time slot as a silent time slot.

Stage (c) shows that some external node wants to participate and to this end one of the time slots requested by the node n₂₃ is designated as a registration slot for the new node.

Stage (d) shows the status relating to node n₂₃. Thus, the time slots are labeled T for transmission slot, S for silent slots and R for registration slots. Unlabeled time slots are candidates for transmitting data.

The node n₂₃ is required to transmit with a predetermined transmission frequency; therefore in slots 5 and 9 the node n₂₃ transmission opportunity is cancelled since were the node to transmit in slots 5 and 9 as well as slots 1 and 8, the resulting transmission frequency would exceed the predetermined transmission frequency.

FIG. 9 shows the access status vectors for all nodes. It can be seen that the nodes transmit without collisions, with registration ability and with high-rate continuous data transmission.

For instance:

(a) High-rate continuous data transmission: the nodes numbered 23 and 46 both transmit in the slot number 8;

(b) Registration ability: node 23 has registration ability in slot 16 whilst node 46 has registration ability in slots 3 and 12;

(c) Without collisions: nodes 2, 11, 23 are transmitting without collisions. Likewise, although in slot 5 both nodes 2 and 46 transmit, they too do not collide because, as seen in FIG. 2, they are not within communication range of each other.

### Top Level Flowchart of Method of Network Node and Verbal Description

The method according to the invention allows many nodes in a dynamic network to share media, for effective data communication between a finite number

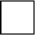

of nodes, wherein each of the nodes can both transmit and receive data over a maximum predetermined distance and may receive only one data communication at any given time.

A description of the top level of the MAC Method is presented below. Method processing is executed on each node, and on each network. In addition, each individual block in the flowchart can be further decomposed onto its constituent flowchart, and so on until the level of primitives is reached.

The present invention also relates to a wireless communication networking system for mobile nodes interconnecting and sharing a communication channel, the system including a plurality of maximum N mobile nodes. Each node, of the plurality of nodes, has a transmitter and a receiver for interconnecting and sharing a communication channel in accordance with a predetermined distributed medium access control protocol. The communication channel is divided as a function of time into time cycles each having a predetermined number of S time slots. The communication channel is global time synchronized for each node of the plurality of mobile nodes. Each node has a predetermined unique identifier. The transmitter and the receiver of each node substantially serve a mutual communication coverage area for transmitting and receiving of frames therein on the channel in broadcasts mode. The transmitting is according to a mutually exclusive transmission schedule whereby each mobile node transmits a frame during a time slot when there is highest priority of accessing of the shared communication channel. The distributed control medium access protocol includes interchanging access status of time slots for a next time cycle between nodes, using commonly defined access identification MATSP data by all nodes, and wherein the transmission scheduling includes each node determining access status of time slots for a respective next time cycle.

Alternatively, the processor of each mobile node may power off its transmitter during time slots other than during those slots when the node is allowed to transmit a frame to the other nodes in accordance with the access identification MATSP data for all nodes of the transmission schedule.

According to another embodiment, the distributed control medium access protocol is adapted to define conditions for each processor so that the transmitting of frames by each transmitter is substantially performed by each node finding a less than full free-collision transmission vector, so as to avoid collision with frames transmitted from other nodes transmitting.

Preferably, the processor of each mobile node defines the distributed control medium access protocol to include a transmission opportunity for each node by including frequency of access of a node, substantially according to: nodes of distance D1 and D2 for the node; highest MATSP access time slots; a node's transmission data capacity; and transmission data capacity of other nodes.

In alternative embodiments, there is provided a distributed control medium access protocol for a plurality of nodes interconnecting and sharing a communications channel, wherein the processor in each node performs the operations (identified by the appropriate blocks shown in FIGS. 4a and 4b):

(a) receiving a frame (block 2);

(b) transmitting a frame (block 2);

(c) forming and updating a communication topology table including sets of identifiers of new and present nodes of distance D1 and D2 for the node (blocks 4, 5 and 14);

(d) for each current time slot, determining and executing a frame receiving or a frame transmitting, according to previously defined access status of the time slot (block 2);

(e) before each frame transmitting, scheduling the node's access status time slots for a next time cycle (block 9);

(f) after each frame receiving, updating an access status table at next time cycle intervals for each node of distance D1 and D2 (blocks 4 and 5); and

(g) before substantially each first time slot of the next time cycle interval, determining the access status of time slots at current and next time cycle intervals of the node and of each node of distance D1 and D2 (block 15).

In the embodiment shown in FIGS. 4a and 4b and represented by block 2 in FIG. 4a, the receiver of each mobile node is coupled to the communication channel, and the receiver conveys to the processor of the respective node received frames originating from other transmitting nodes or interconnection data in said frames.

Preferably, transmitting a frame is invoked by the processor of a node establishing interconnection data associated with each transmitter.

In addition, block 2 relates to an embodiment wherein the processor of a mobile node powers off its receiver during time slots other than those intervals when the respective node is expected to receive in a transmission of an information part of a frame from another node, the expected reception being according to scheduled access status time cycle information previously received from the other nodes.

In FIG. 4a, block 5 relates to an embodiment wherein the processor of a mobile node updates an internally stored access status table after each frame is received from another node in the communication coverage area, and the updating is using:

(a) received information contained in the access status time slots of a respective next time cycle interval field;

(b) indirect received information contained in the HPN of time slots of the next time cycle interval field; and

(c) a silent time slot (STS) access status corresponding to respective time slot for each node as determined from the identifiers of the neighbors' nodes field having higher MATSP than current high MATSP node.

(d) received information contained MAPL from another near node

Also, blocks 4 and 5 relate to an embodiment wherein the processor of a mobile node registers a new node into the transmission schedule using a randomized slot assignment criterion, the criterion being a part of the predetermined distributed medium access protocol. Preferably, in such case, the processor of a mobile node registers a new node neighbor to any other node of the plurality of nodes by using a communication channel and by using thereon a contention type random registration of the new node neighbor to the any other node of said plurality of nodes.

In FIG. 4a, block 9 relates to an embodiment wherein the processor of a mobile node registers a new node into the transmission schedule according to a prearranged scheduling calculation, the calculation being a part of the predetermined distributed medium access protocol. Preferably, in such case, for new node neighbors, the processor of a mobile node registers slot access status by randomly assigning a predefined percent (R) of the registration slots.

Preferably, as shown in blocks 6 to 9 in FIG. 4a, a node's processor determines access status of time slots by assigning an access relation of nodes to a communication channel for the time slot of the following types:

(a) a transmission slot (TS) having a predetermined access time slot status of a transmission opportunity for a node to transmit a frame to the other nodes, when said node is a HPN;

(b) a candidate transmission slot (CTS) having a predetermined access time slot status of a desire for transmission opportunity for a node to transmit a frame to the other nodes, when said node is not a HPN;

(c) a silent time slot (STS) having a predetermined access time slot status of a revoked transmission opportunity for a node to transmit a frame to the other nodes; and

(d) a registration slot (RS) having a predetermined access time slot status of a registration opportunity for a node to receive a frame from a new neighbor node, when said node has a HPN.

(e) a occupied transmission slot (OTS) having a predetermined access time slot status of a transmission opportunity for a node when said node has highest MAPL between near nodes

Preferably, access to the shared communication channel of a HPN of a time slot is indicated by a high priority access right of said node in said time slot.

Also preferably, the processor of each mobile node assigns the HPN status to a node in a transmission schedule according to access identification MATSP data and according to sets of node identifications when an access time slot status has not been assigned to a respective status silent time slot (STS).

Furthermore, according to the preferred embodiment, there is stored in the memory of each mobile node an access identification MATSP data using a predefined node identifications set of size N for each time slot (stored in the system memory). Each of the sets is arranged so that each node identification appears once; and such that the sets can be independently defined for each time slot.

In FIG. 4b, block 15 relates to an embodiment wherein the processor of each node determines, before a first time slot of a next time cycle interval, an access status of time slots at current and next time cycle intervals of the node for all nodes of distance D1 and D2 by:

(a) assigning an access status of time slots at a current time cycle interval to a next time cycle interval of the node and for all nodes of distance D1 and D2 from the node; and

(b) determining a candidate transmission slot (CTS) access time slot status for a next time cycle interval of the node and for all nodes of distance D1 and D2 from the node.

Preferably, the processor of each mobile node defines the distributed control medium access protocol to include a module for each node wherein there is stored:

(a) information to identify the node;

(b) a communication topology table including sets of identifiers of nodes of distance D1 and D2 for said node, in accordance with received frames;

(c) communication channel access identification MATSP data for each time slot;

(d) access status of time slots at current and next time cycle intervals;

(e) access status of time slots at current and next time cycle intervals for each node of distance D1 from the node, in accordance with received frames;

(f) access status of time slots at current and next time cycle intervals for each node of distance D2 from the node, in accordance with calculated data from the received frames;

(g) from the sets of identifiers of nodes of distance D1 and D2 from the node, a time of last notifying of a corresponded node for each such node.

(h) MAPLs of said node and nodes of distance D1.

With further reference to the identified blocks in FIGS. 4a and 4b, each processor forms and updates a communication topology table having sets of identifiers of nodes of distance D1 and D2 of each node by:

(a) updating sets of identifiers of nodes of distance D1 and D2 for each node, after each receives a frame, in accordance with the identifier of the frame source node field and the identifiers of the neighbors' nodes field (blocks 4 and 5); and

(b) deleting nodes from the sets of identifiers of nodes of distance D1 and D2 for each node, that are not confirmed during D time slots in accordance with storing time (stamp) of a last (most recent) notifying (block 14).

With further reference to the identified blocks in FIGS. 4a and 4b, for each current time slot the processor of each node performs the steps of determining and executing a frame receiving or a frame transmitting in accordance with each respective node's previously defined access status for the time slot, by the node:

(a) forming and transmitting a frame, upon determining that the time slot has been assigned to TS access status (block 9);

(b) giving a transmission opportunity to other network nodes, upon determining that the time slot has been assigned to RS or STS access statuses (block 2);

(c) for a node having highest priority and being from the identifiers of nodes of distance D1 and D2, determining TS access time slot status, upon determining that the time slot has been assigned to CTS access status (block 7); and

(d) for maintaining a predetermined percent of the registration slots (R), randomly determining reassigning of appropriate time slots to RS access status, upon determining that the time slot has been assigned to TS access status (block 9).

(e) for a node having highest MAPL and being from the identifiers of nodes of distance D1, determining OTS access time slot status, upon determining that the time slot has been assigned to STS access status (block 5); and

With further reference to block 9 in FIG. 4a, the processor of a node schedules its own access status for time slots in a next time cycle interval by:

(a) determining if time slots having status CTS for a node have highest priority from a set of identifiers for nodes of distance D1 and D2;

(b) upon determining that the node in time slots has been assigned to HPN, determining time slots assignment to TS access status, within known limits for the node's own transmission data capacity and for transmission data capacity of other nodes;

(c) upon determining that the time slot has been assigned to TS access status, determining time slots reassignment to RS access status, within a predetermined percent of the registration slots limitation;

(d) upon determining that the time slot has been assigned to CTS access status, determining time slots exceeding the node's own transmission data capacity, and reassigning these time slots to STS access status; and

(e) determining time slots for nodes of distance D1 as nodes having highest priority.

(f) upon determining that the node in time slots has been assigned to highest MAPL node, determining time slots assignment to OTS access status, within known limits for the node's own transmission data capacity;

Preferably, each address and control portion of the transmit and receive frames of the distributed control medium access protocol, include:

(a) an identifier of the frame source node as a field;

(b) an identifier of the destination node, as a field, or as a broadcast mode definition;

(c) identifiers for neighbors' nodes of distance D1 as fields;

(d) scheduled access status for time slots in a next time cycle interval of a node as a field;

(e) HPNs for each time slot in a next time cycle interval as fields which are assigned with the access identification priority data from the identifiers of the node and of the neighbors of a said node.

(f) MAPLs for neighbors' nodes of distance D1 as fields;

Additional advantages and modifications will readily occur to those skilled in the art. Therefore, the invention in its broader aspects is not limited to the specific details and representative systems embodiments, shown or otherwise described herein.

Numbers, alphabetic characters and roman symbols are designated in the following claims for convenience of explanations only and should not be regarded as imposing particular order on the operations set forth in the method.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The present invention has been described with a certain degree of particularity, however those versed in the art will readily appreciate that various modifications and alterations may be carried out without departing from the spirit and scope of the following claims.

1. A method for allocating a transmission time slot to a node in a distributed mobile ad hoc transmission network having a plurality of nodes each having transmitting and receiving capability via a common communications channel using a predetermined protocol and each having a respective Media Access Priority Level within a range of Media Access Priority Levels such that any two nodes may have different Media Access Priority Levels, the method comprising:
mutually synchronizing according to a global time schedule, among at least two of the nodes, substantially repeating transmission-access cycles of communications slots;
scheduling, among the at least two nodes, a present schedule of transmission reservations wherein each of the at least two nodes is allocated a transmission allocation having in each transmission-access cycle a number of transmission time slots that define a nominal priority (MATSP) for each node based on its position in the transmission schedule for the respective time slot, and wherein said nominal priority is further refined based on the respective Media Access Priority Level of the node and wherein there is a registration slot allocation of at least one slot in an aggregation of cycles of communications slots; and
each of the at least two nodes maintaining a next schedule of transmission reservations, such that:
at least two of the at least two nodes actively renew their respective transmission allocations in a next schedule by transmitting in at least one of its transmission allocation slots in a present schedule for which its nominal priority (MATSP) is highest and there is no other node that wants to transmit in said time slot that has a higher MAPL priority;
any node of the plurality of nodes may apply to the at least two nodes for allocation of at least one transmission slot in the next schedule, by said any node transmitting during a registration slot to the at least two nodes who are actively renewing their transmission allocation; and
at least one registration slot is allocated in the next schedule.

2. A method for reserving access in a distributed mobile ad hoc communications network, said network having a plurality of nodes each having transmitting and receiving capability with respect to a common single communications channel in accordance with a predetermined protocol and each of said nodes having a predetermined unique identifier, the method comprising:
logically dividing a time domain of the channel into a predetermined aggregation of cyclically repeating slots that define a nominal priority (MATSP) for each node based on its position in the transmission schedule for the respective time slot, and wherein said nominal priority further is refined based on the respective Media Access Priority Level of the node, and among the plurality of nodes globally synchronizing the time domain for the slots or for a predetermined plurality thereof; and
among the plurality of nodes scheduling and maintaining a dynamic transmission reservation schedule wherein each node is allocated at least one slot in each aggregation and wherein at least one registration slot is allocated in each aggregation for use by any new node applying to become included as a member in a future transmission reservation schedule; wherein
each node in the plurality maintains its membership in the transmission reservation schedule by transmitting in at least one of its allocated slots in each aggregation for which its nominal priority (MATSP) is highest and there is no other node that wants to transmit in said time slot that has a higher MAPL priority;
each node in the plurality deletes any other node from membership in each of said node's maintained transmission reservation schedule when said other node fails to maintain his membership; and
any node, new or otherwise, may apply to the remaining members of the plurality for allocation of a slot in the transmission reservation schedule, by said any node transmitting, during one of the at least one registration slot, at least his unique identifier as a request for reservation access and membership.

3. A distributed mobile ad hoc wireless communication networking method for mobile nodes interconnecting and sharing a communication channel, the method comprising:
establishing a distributed medium access control protocol, defining interchanging access status of time slots for every next time cycle between nodes, and access identification priority data for all nodes;
dividing the communication channel as a function of time into cycles each having a predetermined number of S time slots;
global time synchronizing the communication channel for each node of a plurality of maximum N mobile nodes;
for each node, defining a unique identifier and a respective Media Access Priority level within a range of Media Access Priority Levels such that any two nodes may have different Media Access Priority Levels;
for each node, providing a transmitter and a receiver substantially serving a mutual communication coverage area for transmitting and receiving of frames therein on the channel in broadcast mode;
scheduling a mutually exclusive transmission schedule wherein each node determines access status of time slots for a respective next time cycle that define a nominal priority (MATSP) for each node based on its position in the transmission schedule for the respective time slot, and wherein said nominal priority is further refined based on the respective Media Access Priority Level of the node and whether data is to be transmitted by the node and wherein there is a registration slot allocation of at least one slot in an aggregation of cycles of communications slots; and
transmitting according to the transmission schedule whereby each mobile node that wants to transmit transmits a frame during a respective time slot for which its nominal priority (MATSP) is highest and there is no other node that wants to transmit in said time slot that has a higher MAPL priority.

4. The method according to claim 1, wherein the scheduling for each node is a function of data to be transmitted by the node and in accordance with which data the MAPL of the node is calculated or whether the node wishes to remain silent in the scheduled time slot.

5. A computer program comprising computer program code means for performing the method of claim 1 when said program is run on a computer.

6. A computer program as claimed in claim 5 embodied on a computer readable medium.

7. A distributed mobile ad hoc wireless communication networking system comprising a plurality of maximum N mobile nodes, such that:
each mobile node has a processor, a transmitter and a receiver both coupled to the processor,
the mobile nodes interconnect to and thereby share a communication channel in accordance with a predetermined distributed medium access control protocol, wherein:
the communication channel is divided into time cycles each having a predetermined number of S time slots that define a nominal priority (MATSP) for each node based on its position in the transmission schedule for the respective time slot, and wherein said nominal priority is further refined based on the respective Media Access Priority Level of the node, and
the communication channel is global time synchronized for each node of the plurality of mobile nodes;
each node has a predetermined unique identifier and a respective Media Access Priority Level within a range of Media Access Priority Levels such that any two nodes may have different Media Access Priority levels;
the transmitter and the receiver of each node substantially serve a mutual communication coverage area for transmitting and receiving of frames therein on the channel in broadcast mode; and
the transmitting is according to a mutually exclusive transmission schedule whereby a selected mobile node (HPN) transmits a frame during a time slot for which its nominal priority (MATSP) is highest and there is no other node that wants to transmit in said time slot that has a higher MAPL priority.

8. The system according to claim 7 wherein the processor of each mobile node powers off its transmitter during time slots other than those slots when the node is allowed to transmit a frame to the other nodes in accordance with the access identification MATSP data for all nodes and in accordance with MAPL data for all near nodes of the transmission schedule.

9. The system according to claim 7 wherein the processor of a mobile node registers a new node into the transmission schedule using a randomized slot assignment criteria, the criteria being a part of the predetermined distributed medium access protocol.

10. The system according to claim 7 wherein the processor of a mobile node registers a new node into the transmission schedule according to a prearranged scheduling calculation, the calculation being a part of the predetermined distributed medium access protocol.

11. The system according to claim 7 wherein the processor of a mobile node powers off its receiver during time slots other than those intervals when the respective node is expected to receive in a transmission of an information part of a frame from another node, the expected reception being according to scheduled access status time cycle information previously received from the other nodes.

12. The system according to claim 7 wherein the distributed control medium access protocol includes defining conditions for each processor so that a transmitting of frames by each transmitter is substantially by each node finding a sub-full free-collision transmission vector, so as to avoid collision with frames transmitted from other nodes transmitting.

13. The system according to claim 7 wherein the processor of a mobile node updates an internally stored access status table after each frame is received from another node in the communication coverage area, in accordance with:
received information contained in the access status time slots of a respective next time cycle;
indirect received information contained in the HPN of time slots of the next time cycle;
a silent time slot (STS) access status corresponding to respective time slot for each node as determined from the identifiers of the neighbors' nodes field having higher MATSP than current highest MATSP node; and
received information contained a Media Access Priority Level of each near neighbors' node.

14. The system according to claim 7 wherein the distributed control medium access protocol includes, for a plurality of nodes interconnecting and sharing a communications channel, the processor in each node being adapted to:
receive a frame;
transmit a frame;
form and update a communication topology table including sets of identifiers of nodes of distance D1 and D2 for the node;
for each current time slot, determine and execute a frame receiving or a frame transmitting, according to previously defined access status of the time slot;
before each frame transmitting, schedule the node's access status time slots for a next time cycle;
after each frame receiving, update an access status table at next time cycle intervals for each node of distance D1 and D2; and
before substantially each first time slot of the next time cycle interval, determine the access status of time slots at current and next time cycle intervals of the node and of each node of distance D1 and D2.

15. The system according to claim 7 wherein a node's processor determines access status of time slots by assigning an access relation of nodes to a communication channel for the time slot using:
a transmission slot (TS) having a predetermined access time slot status of a transmission opportunity for a node to transmit a frame to the other nodes, when said node is a HPN;
a candidate transmission slot (CTS) having a predetermined access time slot status of a desire for transmission opportunity for a node to transmit a frame to the other nodes, when said node is not a HPN;
a silent time slot (STS) having a predetermined access time slot status of a revoked transmission opportunity for a node to transmit a frame to the other nodes;
a registration slot (RS) having a predetermined access time slot status of a registration opportunity for a node to receive a frame from a new neighbor node, when said node is a HPN; and
an occupied transmission slot (OTS) having a predetermined access time slot status of a transmission opportunity for a node when said node has highest MAPL among near nodes.

16. The system according to claim 14 wherein access to the shared communication channel of a HPN of a time slot is indicated by a high priority access right of said node in said time slot.

17. The system according to claim 15 wherein access to the shared communication channel of a HPN of a time slot is indicated by a high priority access right of said node in said time slot.

18. The system according to claim 14, wherein the processor of each mobile node assigns the HPN status to a node in a transmission schedule according to access identification MATSP data and according to MAPL data and according to sets of node identifications when an access time slot status has not been assigned to a respective status silent time slot (STS).

19. The system according to claim 14 wherein:
(a) the processor of each mobile node assigns access identification MATSP data using a predefined node identifications set of size N for each time slot, and each of the sets is arranged so that each node identification appears once such that the sets can be independently defined for each time slot; and
(b) the processor of each mobile node assigns access identification MAPL data using a predefined node PL set for each node.

20. The system according to claim 15 wherein:
(c) the processor of each mobile node assigns access identification MATSP data using a predefined node identifications set of size N for each time slot, and each of the sets is arranged so that each node identification appears once such that the sets can be independently defined for each time slot; and
(d) the processor of each mobile node assigns access identification MAPL data using a predefined node PL set for each node.

21. The system according to claim 9 wherein the processor of a mobile node registers a new node neighbor to any other node of the plurality of nodes by using a communication channel and by using thereon a contention type random registration of the new node neighbor to the any other node of said plurality of nodes.

22. The system according to claim 10 wherein for new node neighbors, the processor of a mobile node registers slot access status by randomly assigning a predefined percent (R) of the registration slots.

23. The system according to claim 7 wherein the processor of each mobile node defines the distributed control medium access protocol to include a transmission opportunity to each node by including frequency of access of a node, substantially according to: nodes of distance D1 and D2 for the node; highest MATSP access time slots; highest MAPL nodes of distance D1; a node's transmission data capacity; and transmission data capacity of other nodes.

24. The system according to claim 14 wherein for the processor of each node, before a first time slot of a next time cycle interval, an access status of time slots at current and next time cycle intervals of the node is determined for all nodes of distance D1 and D2 by:
assigning an access status of time slots at a current time cycle interval to a next time cycle interval of the node and for all nodes of distance D1 and D2 from the node; and
determining a candidate transmission slot (CTS) access time slot status for a next time cycle interval of the node and for all nodes of distance D1 and D2 from the node.

25. The system according to claim 15 wherein for the processor of each node, before a first time slot of a next time cycle interval, an access status of time slots at current and next time cycle intervals of the node is determined for all nodes of distance D1 and D2 by:
assigning an access status of time slots at a current time cycle interval to a next time cycle interval of the node and for all nodes of distance D1 and D2 from the node; and
determining a candidate transmission slot (CTS) access time slot status for a next time cycle interval of the node and for all nodes of distance D1 and D2 from the node.

26. The system according to claim 7 wherein the processor of each mobile node defines the distributed control medium access protocol to include a memory module for each node wherein is stored:
information to identify the node;
a communication topology table including sets of identifiers of nodes of distance D1 and D2 for said node, in accordance with received frames;
communication channel access identification MATSP data for each time slot;
access status of time slots at current and next time cycle intervals;
access status of time slots at current and next time cycle intervals for each node of distance D1 from the node, in accordance with received frames;
access status of time slots at current and next time cycle intervals for each node of distance D2 from the node, in accordance with calculated data from the received frames;
from the sets of identifiers of nodes of distance D1 and D2 from the node, a time of last notifying of a corresponded node for each such node; and
MAPLs of nodes within a distance D1 from said node.

27. The system according to claim 7 wherein the receiver of each mobile node is coupled to the communication channel, and said receiver conveys to the processor of said node a receiving of frames originating from other transmitting nodes or interconnection data in said frames.

28. The system according to claim 7 wherein transmitting a frame includes therein the processor of a node establishing interconnection data associated with each transmitter.

29. The system according to claim 14 wherein each processor forms and updates a communication topology table having sets of identifiers of nodes of distance D1 and D2 of each node by:
updating sets of identifiers of nodes of distance D1 and D2 for each node, after each receives a frame, in accordance with the identifier of the frame source node field and the identifiers of the neighbors' nodes field; and
deleting nodes from the sets of identifiers of nodes of distance D1 and D2 for each node, that are not confirmed during D time slots in accordance with storing time of last notifying.

30. The system according to claim 15 wherein each processor forms and updates a communication topology table having sets of identifiers of nodes of distance D1 and D2 of each node by:
updating sets of identifiers of nodes of distance D1 and D2 for each node, after each receives a frame, in accordance with the identifier of the frame source node field and the identifiers of the neighbors' nodes field; and
deleting nodes from the sets of identifiers of nodes of distance D1 and D2 for each node, that are not confirmed during D time slots in accordance with storing time of last notifying.

31. The system according to claim 14 wherein for the processor of each node determining and executing for each current time slot, in accordance with said each node's previously defined access status for the time slot, includes said node:
forming and transmitting a frame, upon determining that the time slot has been assigned to TS access status;
giving a transmission opportunity to other network nodes, upon determining that the time slot has been assigned to RS or STS access statuses;
for a node having highest access priority and being from the identifiers of nodes of distance D1 and D2, determining TS access time slot status, upon determining that the time slot has been assigned to CTS access status;
randomly determining reassigning of appropriate time slots to RS access status, upon determining that the time slot has been assigned to TS access status in order to maintain a predetermined percent of registration slots (R); and
for a node having data to transmit and highest access MAPL and being from the identifiers of nodes of distance D1, determining OTS access time slot status.

32. The system according to claim 15 wherein for the processor of each node determining and executing for each current time slot, in accordance with said each node's previously defined access status for the time slot, includes said node:
forming and transmitting a frame, upon determining that the time slot has been assigned to TS access status;
giving a transmission opportunity to other network nodes, upon determining that the time slot has been assigned to RS or STS access statuses;
for a node having highest access priority and being from the identifiers of nodes of distance D1 and D2, determining TS access time slot status, upon determining that the time slot has been assigned to CTS access status;
randomly determining reassigning of appropriate time slots to RS access status, upon determining that the time slot has been assigned to TS access status in order to maintain a predetermined percent of registration slots (R); and
for a node having data to transmit and highest access MAPL and being from the identifiers of nodes of distance D1, determining OTS access time slot status.

33. The system according to claim 14 wherein the processor of a node schedules its own access status for time slots in a next time cycle interval by:
determining if time slots having status CTS for a node do not have highest priority from a set of identifiers for nodes of distance D1 and D2;
upon determining that the time slot has been assigned to HPN status, determining time slots assignment to TS access status, within known limits for the node's own transmission data capacity and for transmission data capacity of other nodes;
upon determining that the time slot has been assigned to TS access status, determining time slots reassignment to RS access status, within a predetermined percent of registration slots limitation;
upon determining that the time slot has been assigned to CTS access status, determining time slots exceeding the node's own transmission data capacity, and reassigning these time slots to STS access status; and
determining time slots for nodes of distance D1 as nodes having highest priority.

34. The system according to claim 15 wherein the processor of a node schedules its own access status for time slots in a next time cycle interval by:
determining if time slots having status CTS for a node do not have highest priority from a set of identifiers for nodes of distance D1 and D2;
upon determining that the time slot has been assigned to HPN status, determining time slots assignment to TS access status, within known limits for the node's own transmission data capacity and for transmission data capacity of other nodes;
upon determining that the time slot has been assigned to TS access status, determining time slots reassignment to RS access status, within a predetermined percent of registration slots limitation;
upon determining that the time slot has been assigned to CTS access status, determining time slots exceeding the node's own transmission data capacity, and reassigning these time slots to STS access status; and
determining time slots for nodes of distance D1 as nodes having highest priority.

35. The system according to claim 7 wherein each processor includes in address and control parts of frames of the distributed control medium access protocol:
an identifier of the frame source node as a field;
an identifier of the destination node, as a field, or as a broadcast mode definition;
identifiers for neighbors' nodes of distance D1 as fields;
scheduled access status for time slots in a next time cycle interval of a node as a field;
high priority nodes for each time slot in a next time cycle interval as fields which are assigned with the access identification priority data from the identifiers of the node and of the neighbors of a said node.

36. The system according to claim 13 wherein a node's processor determines ST access status of time slots as a function of:
number of D1 and D2 nodes;
MAPLs of the node and of the D1 nodes of said node; and
data to transmit of application of said node.

37. The system according to claim 7, wherein the transmission schedule is a function of data to be transmitted by the node and in accordance with which data the MAPL of the node is calculated or whether the node wishes to remain silent in the scheduled time slot.
